(19) United States
(12) Patent Application Publication
(10) Pub. No.: US 2007/0074776 A1
(43) Pub. Date: Apr. 5, 2007

(54) Irrigation pipe

(76) Inventors: Abed Masarwa, Taibe (IL); Avi Schweitzer, D.N. Hanegev (IL)

Correspondence Address: NATH & ASSOCIATES, 112 South West Street, Alexandria, VA, 22314, US

(21) Appl. No.: 11/240,630

(22) Filed: Oct. 3, 2005

(51) Int. Cl. F16L 11/00

(52) U.S. Cl. 138/124; 138/128; 138/130; 239/542; 239/547

(57) ABSTRACT

An irrigation pipe comprising at least one layer is provided. The layer has a maximum longitudinal tensile stress in the longitudinal direction of the pipe and a maximum tensile hoop stress along the circumference of the pipe. The value of the maximum longitudinal tensile stress is substantially less than the value of the maximum tensile hoop stress.

### FIELD OF THE INVENTION

This invention relates to irrigation pipes.

### BACKGROUND OF THE INVENTION

Irrigation pipes having several layers are well known in the art. For example, U.S. Pat. No. 6,588,456 discloses a pressure-resistant hose and forming method thereof, which is capable of effectively spouting liquid or gas of high pressure even though the pressure-resistant hose is of a relatively small thickness. The pressure-resistant hose comprises a first polyethylene mixture and one or more second hose layers. The first hose layer is formed by bonding together longitudinal ends of a first polyethylene mixture fabric coated with one or two watertight films at one or both surfaces of the first polyethylene mixture fabric. Each of the second hose layers if formed by bonding together longitudinal ends of a second polyethylene mixture fabric coated with one or two watertight films at one or both surfaces of the second polyethylene mixture fabric.

### SUMMARY OF THE INVENTION

It is well known that pressure, such as internal hydrostatic pressure, inside a closed vessel causes the walls of the vessel to undergo stress. In a cylindrical vessel, such as a pipe (illustrated schematically in FIG. 1), the hoop stress, i.e., the stress around the circumference of the cylinder, is given by:

$${σ}_{hoop} = \frac{p r}{t}$$

where:
σₕₒₒₚ is the hoop stress;
p is the internal pressure;
r is the radius of the pipe; and
t is the thickness of the wall.

The longitudinal stress, i.e., the stress in along the length of the pipe, of the same vessel is given by:

$${σ}_{longitudinal} = \frac{p r}{2 t}$$

where σ_{longitudinal} is the longitudinal stress. From these two equations, it is clear that the walls of a pipe under internal hydrostatic pressure experience, under ideal conditions, twice the stress in the circumferential direction as they do in the longitudinal direction.

It is therefore an object of the present invention to provide an irrigation pipe which is designed to withstand both longitudinal and hoop stresses without being over-designed for either.

According to one aspect of the present invention, there is provided an irrigation pipe comprising at least one layer which has a maximum longitudinal tensile stress in the longitudinal direction of the pipe and a maximum tensile hoop stress along the circumference of the pipe, wherein the value of the maximum longitudinal tensile stress is substantially less than the value of the maximum tensile hoop stress.

The pipe may be formed by bending a sheet into a tube shape, with two parallel edges thereof being bonded together.

According to one embodiment, the value of maximum longitudinal tensile stress is between one half and two thirds the value of the maximum tensile hoop stress.

The layer may be made from a material comprising longitudinal fibers being oriented substantially in the longitudinal direction of the pipe, and hoop fibers being oriented substantially along the circumference of the pipe. According to one modification, the value of the maximum tensile stress of the longitudinal fibers is substantially higher than the value of the maximum tensile stress of the hoop fibers. According to another modification, the number of longitudinal fibers is substantially higher than the number of hoop fibers per square unit of the material.

The irrigation pipe may further comprise at least one irrigation accessory integrally formed thereon.

According to another aspect of the present invention, there is provided an irrigation pipe having physical threshold values associated with its hoop direction and with its longitudinal direction, wherein at least some of the values associated with the hoop direction differ from the corresponding values in the longitudinal direction. These value may be, for example, may be the values of maximum tensile strength in the hoop and longitudinal directions, and/or the values of heat resistance in the hoop and longitudinal directions.

### BRIEF DESCRIPTION OF THE DRAWINGS

In order to understand the invention and to see how it may be carried out in practice, an embodiment will now be described, by way of a non-limiting example only, with reference to the accompanying drawings, in which:

FIG. 1 is a schematic cross-sectional view of a cylindrical pressure vessel;

FIG. 2 is cross-sectional perspective view of an irrigation pipe according to the present invention;

FIG. 3 is an enlarged view of material used in an intermediate layer of the irrigation pipe illustrated in FIG. 1;

FIG. 4A illustrates a sheet of material used to form the intermediate layer; and

FIG. 4B illustrates the material being shaped to form the intermediate layer.

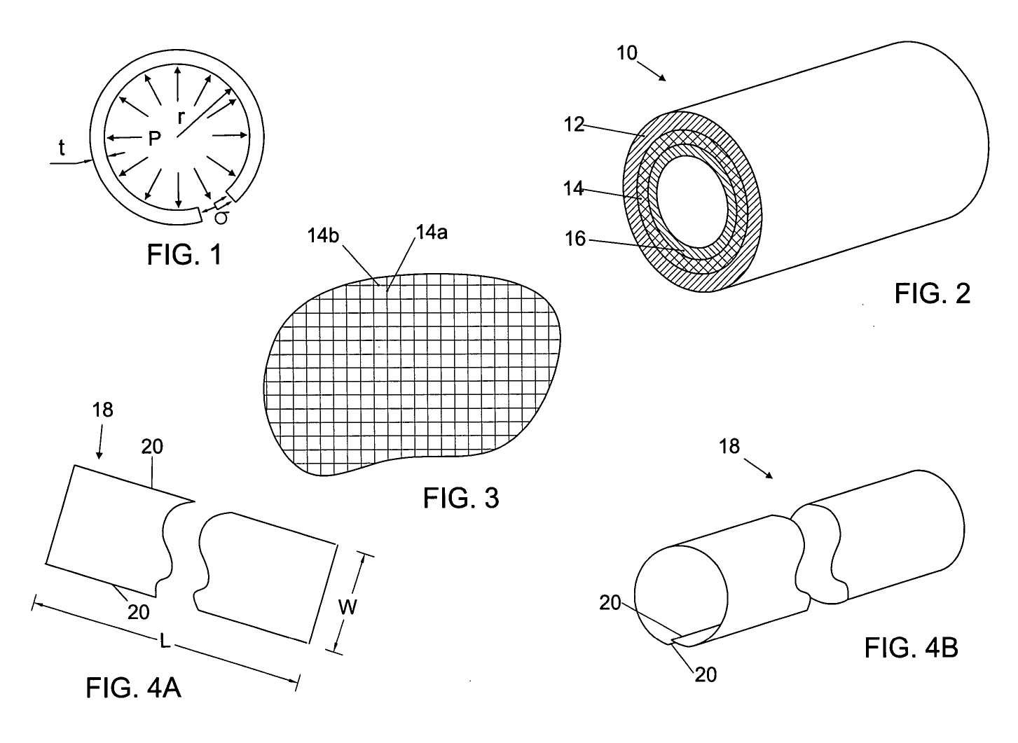

### DETAILED DESCRIPTION OF EXEMPLARY EMBODIMENTS

FIG. 2 illustrates, in cross-section, an irrigation pipe 10 according to one embodiment of the present invention. It comprises an outer layer 12, an intermediate layer 14, and an inner layer 16. The outer and inner layers 12, 16 may be made from a water-repellant material such as PE, PP, PVC, TPE, elastomers, or a copolymer. They serve, inter alia, to protect against ingress of water through the pipe wall.

As seen in FIG. 3, the intermediate layer 14 is made from a porous material, such as a textile, woven on non-woven fabric, or bi-oriented or high-stiffness polymer. As such, it comprises circumferential fibers 14a and longitudinal fibers 14b. The circumferential and longitudinal fibers 14a, 14b are arranged parallel to the circumferential and longitudinal directions of the pipe, respectively.

The fibers 14a, 14b are made into a sheet 18 of the material by any conventional means, such as weaving or pressing. As illustrated in FIG. 4A, the sheet 18 has a length L, equal to the length of the pipe 10, and a width W, which is slightly larger than the circumference of the pipe. As illustrated in FIG. 4B, the sheet 18, along with the material used to form the other layers, is folded to form the pipe, with edges 20 along the length overlapping slightly. The overlapping areas of the edges 20 are bonded by any known means to form a seam, thereby closing the pipe. Alternatively, each layer may be formed separately, starting from the inner layer 16, with each subsequent layer being formed therearound.

The irrigation pipe 10, during use, may be considered, for purposes of calculation, a cylindrical pressure vessel with an internal hydrostatic pressure. As described above, the longitudinal stress in such a vessel under ideal conditions is half the hoop stress. Therefore, the pipe is constructed such that it can withstand hoop and longitudinal stresses without being over-designed either in the longitudinal or circumferential direction.

Accordingly, the fibers are selected and/or arranged such that the maximum tensile strength of the material is substantially less in the longitudinal direction than in the circumferential direction. This may be accomplished either by utilizing a greater density of circumferential fibers 14a than of longitudinal fibers 14b (i.e., more circumferential fibers than longitudinal fibers per unit area), or by selecting circumferential fibers which have a higher maximum tensile strength than that of the longitudinal fibers. These circumferential fibers may be fibers which are thicker, longer, or made from a different material than the longitudinal fibers. Alternatively, a combination of both of the above may be utilized, wherein there is a greater density of circumferential fibers, and the circumferential fibers have a higher maximum tensile strength than that of the longitudinal fibers.

The intermediate layer 14 may alternatively be made from several sub-layers. A first layer may be designed to withstand the required longitudinal stress, and a second layer may be designed to withstand the required hoop stress. They may be cross-laminated according to any known method to form the intermediate layer 14.

The pipe 10 is thus designed to withstand the resultant stresses from internal hydrostatic pressure without being over-designed. The pipe 10 is thus cheaper and/or lighter than it would be otherwise. For large amounts of pipe (such that would be sold commercially), this advantage is significant.

It is well known that with increasing heat, the strength of materials typically used to make pipes decreases. Additives such as Polypropylene (PP) or Cyclic Olefin Copolymer (COC) may be added to mitigate this effect. Therefore, as a modification, some of these additives (e.g., 10-40%) may be used to supplement the circumferential fibers 14a. This need not be done, or may be done to a lesser degree, to the longitudinal fibers 14b, since the stresses experienced thereby are much less.

It will be appreciated that the pipe may be constructed according to any desired design, including using non-fibrous material as the interior layer, using a single-layer pipe, etc., provided that the maximum longitudinal stress of the pipe is substantially less than the maximum hoop stress thereof.

The pipe 10 according to the present invention may optionally be manufactures with one or more integral accessories. For example, emitters, sprinklers, anti-drip valves, drippers, connectors, or pressure regulators may be installed using any known and appropriate method, such as heat-welding, etc.

Those skilled in the art to which this invention pertains will readily appreciate that numerous changes, variations and modifications can be made without departing from the scope of the invention mutatis mutandis.

1. An irrigation pipe comprising at least one layer, said layer having a maximum longitudinal tensile stress strength in the longitudinal direction of the pipe and a maximum tensile hoop strength along the circumference of the pipe, wherein the value of the maximum longitudinal tensile strength is substantially less than the value of the maximum tensile hoop strength, and wherein the at least one layer is formed by bending a sheet into the form of a tube.

2. An irrigation pipe according to claim 1, wherein the value of maximum longitudinal tensile strength is between one half and two thirds the value of the maximum tensile hoop strength.

3. An irrigation pipe according to claim 1, wherein the layer is made from a material comprising longitudinal fibers being oriented substantially in the longitudinal direction of the pipe, and hoop fibers being oriented substantially along the circumference of the pipe.

4. An irrigation pipe according to claim 3, wherein the value of the maximum tensile strength of the circumferential fibers is substantially higher than the value of the maximum tensile strength of the longitudinal fibers.

5. An irrigation pipe according to claim 3, wherein the number of longitudinal fibers is substantially higher than the number of hoop fibers per square unit of the material.

6. (canceled)

7. An irrigation pipe according to claim 1, wherein the at least one layer comprises at least two sub-layers, a first sub-layer having the required maximum longitudinal tensile strength, and a second sub-layer having the required maximum tensile hoops strength.

8. An irrigation pipe according to claim 7, wherein the at least two layers are cross-laminated to form the at least one layer.

9. An irrigation pipe according to claim 1, further comprising at least one accessory integrally formed thereon.

10. An irrigation pipe having physical threshold values associated with its hoop direction and with its longitudinal direction, wherein at least some of the values associated with the hoop direction differ from the corresponding values in the longitudinal direction and wherein the pipe is formed by bending a sheet into the form of a tube.

11. An irrigation pipe according to claim 10, wherein the value of maximum tensile strength in the hoop direction differs from the value of maximum tensile strength in the longitudinal direction.

12. An irrigation pipe according to claim 10, wherein the value of heat resistance in the hoop direction differs from the value of heat resistance in the longitudinal direction.

13. An irrigation pipe comprising at least one layer being made of a material comprising textile fabric, said pipe comprising an additive for increasing the heat resistance of the pipe.

14. An irrigation pipe according to claim 13, wherein the additive is Cyclic Olefin Copolymer.
